(19) United States
(12) Patent Application Publication
(10) Pub. No.: US 2019/0016881 A1
(43) Pub. Date: Jan. 17, 2019

(54) RESIN COMPOSITION FOR CABLE TIE

(71) Applicant: KOREA ENGINEERING PLASTICS CO., LTD., Seoul (KR)

(72) Inventors: Hojoon LEE, Anyang-si (KR); Soonyoung CHA, Ulsan (KR); Jaewon CHOI, Seoul (KR)

(73) Assignee: KOREA ENGINEERING PLASTICS CO., LTD., Seoul (KR)

(21) Appl. No.: 15/750,478

(22) PCT Filed: Jul. 26, 2016
(86) PCT No.: PCT/KR2016/008128

§ 371 Date: Feb. 5, 2018

(30) Foreign Application Priority Data
Aug. 4, 2015 (KR) 10-2015-0109891

(51) Int. Cl. C08L 59/02; C08L 75/06; C08L 25/06; B65B 13/02; C08K 5/00

(52) U.S. Cl. CPC C08L 59/02; C08L 75/06; C08K 5/13; B65B 13/027; C08K 5/005; C08L 25/06

(57) ABSTRACT

Provided is a resin composition for a cable tie, containing a polyoxymethylene resin, a polyester based polyurethane resin, and a polyethylene/octene copolymer. The resin composition for a cable tie may have advantages in that it may have high flowability, be easily molded without requiring a forced moisture absorption process at the time of manufacturing a cable tie, and have excellent physical/chemical stability and durability in addition to excellent mechanical properties.

### TECHNICAL FIELD

The present invention relates to a resin composition for a cable tie.

### BACKGROUND ART

A cable tie is referred to as a tie wrap or a flex tie and used to fix items to a support or hold the items together with the support. A type of cable tie is a special binder such as a cable or wire or a fastener. That is, the cable tie is a device for bundling or harnessing a plurality of items. As an example of the cable tie, there is a single-use expendable for bundling computer wirings, various cable wires, or the like, to neatly arrange the computer wirings or the cable wires.

The cable tie as described above is made of a thermoplastic resin composition, and as characteristics of the thermoplastic resin composition used as the cable tie, excellent mechanical properties such as a high melt flow index, high flexibility, and good toughness, and the like, are required.

In general, the cable tie is manufactured based on a polyamide based resin composition such as Nylon 6, Nylon 66, Nylon 46, Nylon 610, Nylon 612, or the like, or a polypropylene based resin composition. However, the cable tie manufactured based on the resin composition as described above has a problem in that when the cable tie is continuously and repeatedly exposed to a high/low temperature, deformation such as fracture, cutting, cracks, or the like may occur due to deterioration of physical/chemical stability and durability in addition to mechanical properties. For example, a polyamide resin composition having excellent flame resistance and long-term heat resistance, which may be applied to the cable tie has been disclosed in Korean Patent No. KR0877392B1, but there was the above-mentioned problem. Further, a polyamide resin in manufacturing an injection molding product such as a cable tie, or the like, has been disclosed in Korean Patent No. KR1424907B1, but there was a problem similar to the above-mentioned problem.

Therefore, in order to solve the problem, a cable tie is manufactured by further performing a forced moisture absorption process after injection in a manufacturing process. Nevertheless, there are still problems in physical/chemical stability and durability in addition to mechanical properties.

Further, for an easy and precise molding process, a resin composition having high flowability is required, but in a case of manufacturing a molding product using the resin composition having high flowability as described above, there is a problem in that mechanical properties are deteriorated. Particularly, in a case of a relatively thin linear cable tie, there are problems in that a molding process is rather complicated, and mechanical properties are also relatively deteriorated as compared to other molding products.

Therefore, research for preparing a high-flowability resin from which mechanical properties of a molding product finally manufactured are excellent and which has a melting flow or rheological behavior compatible with some molding processes such as an injection molding process has been required. More specifically, the resin should be easily and rapidly transferred and handled in a specific molding device such as an injection molding device and be flowable enough to produce a thin linear molding product such as a cable tie in a melted state.

Therefore, research into a resin composition which has high flowability and from which mechanical properties of a thin linear cable tie manufactured are also excellent has been required.

### RELATED ART DOCUMENT

### Patent Document

Korean Patent No. KR0877392B1

Korean Patent No. KR1424907B1

Korean Patent Laid-Open Publication No. KR10-2004-0047903A

### DISCLOSURE

### Technical Problem

An object of the present invention is to provide a resin composition used to manufacture a cable tie having excellent physical/chemical stability and durability in addition to excellent mechanical properties such as impact strength, tensile elongation, and the like, even in the case in which the cable tie is continuously exposed to a high/low temperature environment.

Another object of the present invention is to provide a resin composition for a cable tie capable of further improving physical/chemical stability and durability while having high flowability (a high melt flow index) and being easily molded without requiring a forced moisture absorption process at the time of manufacturing a cable tie.

### Technical Solution

In one general aspect, a resin composition for a cable tie contains a polyoxymethylene resin, a polyester based polyurethane resin, and an acid-modified polyethylene/octene copolymer.

The composition may contain, for example, 5 to 100 parts by weight of the polyester based polyurethane resin and 0.01 to 20 parts by weight of the acid-modified polyethylene/octene copolymer, based on 100 parts by weight of the polyoxymethylene resin, but is not limited thereto as long as the object of the present invention may be achieved.

The composition may further contain any one or two or more selected from polystyrene, an antioxidant, an additive, and the like.

The resin composition according to the present invention may be used, for example, in a cable tie, and widely used as an engineering plastic but is not limited thereto as long as the object of the present invention may be achieved.

### Advantageous Effects

A resin composition for a cable tie according to the present invention may have excellent physical/chemical stability and durability in addition to excellent mechanical properties even in the case in which the resin composition is continuously exposed to a high/low temperature environment.

Further, the resin composition for a cable tie according to the present invention may have excellent impact strength and tensile elongation.

The resin composition for a cable tie according to the present invention may further improve physical/chemical stability and durability while having high flowability, and may be easily molded without requiring a forced moisture absorption process at the time of manufacturing the cable tie.

### BEST MODE

Hereinafter, a resin composition for a cable tie according to the present invention will be described in detail.

Here, technical terms and scientific terms used in the present specification have the general meaning understood by those skilled in the art to which the present invention pertains unless otherwise defined, and a description for the known function and configuration obscuring the present invention will be omitted in the following description.

In addition, unless particularly described, “%” obscurely used herein refers to “wt %”.

Generally, in the case of injection molding a resin composition to manufacture a cable tie, at the time of injection molding, there is a need to suitably compromise between capacity for treating the preparation and good mechanical properties of a molding product. For example, an injection molding step needs to be performed under conditions at which molding products having various and slightly complicated shapes and molding products of which flowability of a polymer is suitable at an injection molding temperature may be manufactured. This is an important factor for manufacturing a cable tie having a thin thickness. In addition, the molding product manufactured as described above needs also to have excellent mechanical properties such as impact strength, flexural or tensile modulus, flexural or tensile rupture stress, or the like, but in the case in which the flowability is high (a melt flow index is high) as an advantageous condition at the time of molding, mechanical properties of the manufactured molding product may be rather deteriorated. Therefore, a resin composition having a high melt flow index is unlikely to be compatible with excellent mechanical properties of a cable tie manufactured therefrom.

Therefore, an object of the present invention, which is to minimize or solve the above-mentioned problems, is to provide a resin composition for a cable tie capable of being used to manufacture a cable tie having a high melt flow index and excellent mechanical properties.

Hereinafter, the resin composition for a cable tie according to the present invention will be described in detail.

The present invention relates to a resin composition for a cable tie, containing a polyoxymethylene resin, a polyester based polyurethane resin, and an acid-modified polyethylene/octene copolymer.

Generally, in a resin composition used to manufacture a cable tie, a polyamide based resin such as nylon, or the like, is used as a base. However, in the resin composition for a cable tie according to the present invention, the polyoxymethylene resin is used as the base, and thus, even in the case of manufacturing a cable tie through a molding process, a moisture absorption process is not further required later. Therefore, it is possible to prevent reproducibility from being deteriorated by a large deviation in mechanical properties due to moisture absorption.

In an exemplary embodiment of the present invention, the composition may contain, for example, 5 to 100 parts by weight of the polyester based polyurethane resin and 0.01 to 20 parts by weight of the acid-modified polyethylene/octene copolymer, and preferably, 5 to 50 parts by weight of the polyester based polyurethane resin and 0.01 to 10 parts by weight of the acid-modified polyethylene/octene copolymer, based on 100 parts by weight of the polyoxymethylene resin, but is not limited thereto as long as the object of the present invention may be achieved. In the case in which the above-mentioned ranges are satisfied, the deviation in physical properties due to moisture absorption may be further minimized, and respective characteristics to be described below may be further improved. However, this is only a preferable example, but the present invention is not limited thereto.

In the exemplary embodiment of the present invention, when the polyester based polyurethane resin is combined with ingredients according to the present invention such as the polyoxymethylene resin, the acid-modified polyethylene/octene copolymer, and the like, flowability may be maintained (a decrease in a melt flow index may be minimized), and at the same time, even after a molding product is finally manufactured, mechanical properties such as impact strength, tensile elongation, and the like, may be further improved.

In the exemplary embodiment of the present invention, the polyester based polyurethane resin may be, for example, a low-viscosity polyester based polyurethane resin, but is not limited thereto as long as the object of the present invention may be achieved. In addition, the polyester based polyurethane resin may further include an ether based or ester based compound. In the case in which the polyester based polyurethane resin further contains the ether based or ester based compound as described above, side effects of deteriorating the mechanical properties such as impact strength, tensile elongation, and the like, may be further minimized.

In the exemplary embodiment of the present invention, when the acid-modified polyethylene/octene copolymer is combined with the ingredients according to the present invention such as the polyoxymethylene resin, the polyester based polyurethane resin, and the like, the mechanical properties such as impact strength, tensile elongation, and the like, may be further improved.

In the exemplary embodiment of the present invention, the acid-modified polyethylene/octene copolymer may be, for example, an acid-modified polyethylene/octene copolymer, which is modified with maleic acid anhydride, but is not limited thereto as long as the object of the present invention may be achieved. It is preferred that the molar ratio of ethylene to octene [ethylene/octene] of the acid-modified polyethylene/octene copolymer lies in the range of 1 to 2.5, more preferably 1.5 to 2.2. In the case in which the acid-modified polyethylene/octene copolymer as described above is applied, the mechanical properties may be further improved.

In the exemplary embodiment of the present invention, the composition may further contain polystyrene. Here, it is preferable that the polystyrene is, for example, acid-modified polystyrene. More preferably, the polystyrene may be acid-modified polystyrene modified with maleic acid anhydride. In the case in which the polystyrene as described above is combined with the ingredients according to the present invention such as the polyoxymethylene resin, the polyester based polyurethane resin, the acid-modified polyethylene/octene copolymer, and the like, decreases in flexural strength, tensile strength, and the like, may be minimized, such that the resin composition may have a high melt flow index while having suitable elastic modulus, and may further improve impact strength, tensile elongation, and the like.

In the exemplary embodiment of the present invention, the composition may further contain, for example, 0.01 to 20 parts by weight, preferably, 0.01 to 10 parts by weight of acid-modified polystyrene, based on 100 parts by weight of the polyoxymethylene resin, but is not limited thereto as long as the object of the present invention may be achieved. However, this is only a preferable example, but the present invention is not limited thereto.

In the exemplary embodiment in the present invention, weight average molecular weights of the polyoxymethylene resin, the polyester based polyurethane resin, the acid-modified polyethylene/octene copolymer, and the polystyrene may be each independently, for example, 500 to 300,000, but are not limited thereto as long as the object of the present invention may be achieved. However, this is only a preferable example, but the present invention is not limited thereto.

In the exemplary embodiment of the present invention, the composition may further contain an antioxidant. In detail, the composition may further contain, for example, 0.01 to 20 parts by weight, preferably, 0.01 to 10 parts by weight of the antioxidant, based on 100 parts by weight of the polyoxymethylene resin, but is not limited thereto as long as the object of the present invention may be achieved. In addition, an example of the antioxidant may include a phenol based antioxidant, an amine based antioxidant, a phosphite based antioxidant, a thioester based antioxidant, or the like, and it is preferable that the antioxidant is phenol based antioxidant. The phenol based antioxidant may remove a radical group, thereby making it possible to minimize an oxidation phenomenon of the molding product by air, moisture, and the like. However, this is only a preferable example, but the present invention is not limited thereto.

In the exemplary embodiment of the present invention, the phenol based antioxidant may include, for example, any one or two or more selected from tetrakis[methylene(3,5-di-tert-butyl-4-hydroxyphenyl)propionate methane, 1,2-bis(3,5-di-tert-butyl-4-hydroxyhydrocinnamoly) hydrazine, thiodiethylene bis[3-(3,5-di-tert-butyl-4-hydroxyphenyl) propionate], octadecyl-3-(3,5-di-tert-butyl-4-hydroxyphenyl) propionate, isotridecyl-3-(3,5-di-tert-butyl-4-hydroxyphenyl) propionate, N,N′-hexamethylene bis(3,5-di-t-butyl-4-hydroxyhydrocinnamamide), benzenepropanoic acid, C7-9-branched alkyl esters, 2,2′-ethylidenebis(4,6-di-tert-butylphenol), 1,3,5-Triethyl-2,4,6-tris(3,5-di-t-butyl-4-hydroxy benzyl) benzene, triethylene glycol-bis-3-(3-tert-butyl-4-hydroxy-5-methylphenyl) propionate, 2,5-di-tert-amyl-hydroquinone, hexamethylene bis[3-(3,5-di-tert-butyl-4-hydroxyphenyl) propionate], tris-(3,5-di-tert-butylhydroxybenzyl) isocyanurate, and 4,4′-butylidenebis(6-tert-butyl-3-methylphenol), but is not limited thereto as long as the object of the present invention may be achieved. However, this is only a preferable example, but the present invention is not limited thereto.

In the exemplary embodiment, the composition may further contain an additive. Examples of the additive may include a dispersant, a coloring agent, a heat stabilizer, a UV absorber, a hindered amine based photo-stabilizer, a lubricant, an antistatic agent, a flame retardant, a brightener, a slip agent, a releasing agent, a leveling agent, and the like, but are not limited thereto as long as the object of the present invention may be achieved.

In the exemplary embodiment of the present invention, the melt flow index of the composition may be, for example, 10 to 120 g/10 min, preferably, 30 to 100 g/10 min, but is not limited thereto as long as the object of the present invention may be achieved.

In the exemplary embodiment of the present invention, tensile elongation and impact strength of the composition may be independently, for example, 20% or more and 5.0 kJ/m² or more, respectively, but are not limited thereto as long as the object of the present invention may be achieved. In addition, upper limit values thereof are not particularly limited as long as the upper limit values are in possible ranges.

The resin composition according to the present invention may be used in a cable tie, and widely used as an engineering plastic. For example, the resin composition may be variously applied to aircrafts, vehicles, electric and electronic components, various industrial components, miscellaneous goods, and the like. More specifically, in a vehicle field, the resin composition may be representatively used in a component of a fuel system requiring fuel resistance and a component of a window adjustment apparatus requiring friction resistance/abrasion resistance and creep characteristics, in electric and electronic fields, the resin component may be mainly used in a camera, mobile phone, a copying machine, a printer, and gear components, in an industrial field, the resin component may be used in a piping component, a conveyer belt component, a toilet bowl component, and the like. Otherwise, the resin component may be widely used in various fields such as general miscellaneous goods, household goods, and the like.

Hereinafter, the present invention will be described in detail through Examples, but they are provided only for clearly describing of the present invention, and the scope of the present invention is not limited thereby.

### Example 1

Based on 100 parts by weight of a low-viscosity polyoxymethylene resin (KEPITAL® F40-34, Korea Engineering Plastics) having a melt flow index of 64 g/10 min, 25 parts by weight of a low-viscosity polyester based polyurethane resin (NEOTHANE® 7020H Dongsung Hichem), 1.25 parts by weight of a maleic acid anhydride-modified polyethylene/octene copolymer (AMPLIFY® GR 216, Dow Chemical), 0.125 parts by weight of maleic acid anhydride-modified polystyrene (SMA 3000P, CRAY VALLY SA), and 0.25 parts by weight of an antioxidant (SONGNOX® 1010, Songwon Industrial Co., Ltd) were blended in a ribbon mixer for minutes, and then injected into a twin screw extruder to thereby be sufficiently melt-kneaded at 210° C. The resultant was discharged in a spaghetti form through a die, sufficiently cooled in a cooling water tank, and cut in a chip form using a pelletizer, thereby manufacturing a cable tie test sample.

After the test sample was sufficiently dried in an oven at 80° C., a molding product was manufactured by injection molding the test sample for measuring physical properties at 190° C. Thereafter, physical properties of the molding product were measured as described below, and the results were illustrated in the following Table 1.

### Example 2

The same processes were performed as in Example 1 except that the maleic acid anhydride-modified polystyrene of Example 1 was not used.

### Comparative Example 1

The same processes were performed as in Example 1 except that the low-viscosity polyester based polyurethane resin of Example 1 was not used, a content of the maleic acid anhydride-modified polyethylene/octene copolymer was changed from 1.25 parts by weight to 1.0 part by weight, a content of the maleic acid anhydride-modified polystyrene was changed from 0.125 parts by weight to 0.1 parts by weight, and a content of the antioxidant was changed from 0.25 parts by weight to 0.2 parts by weight.

### Comparative Example 2

The same processes were performed as in Example 1 except that the maleic acid anhydride-modified polyethylene/octene copolymer of Example 1 was not used.

The following Table 1 illustrates results obtained by measuring a melt flow index, tensile strength, tensile elongation, flexural strength, flexural modulus, and impact strength of each of the molding products. The melt flow index was measured according to international organization for standardization (ISO) 1133 (190° C., 2.16 kg), the tensile strength was measured according to ISO 527, the flexural strength and the flexural modulus were measured according to ISO 178, and the impact strength (Charpy notched) was measured according to ISO179/1eA.

TABLE 1

| | Melt | | | | | |
|---|---|---|---|---|---|---|
| | Flow | | | | | |
| | Index | Tensile | Tensile | Flexural | Flexural | Impact |
| Classi- | (g/10 | Strength | Elongation | Strength | Modulus | Strength |
| fication | min) | (MPa) | (%) | (MPa) | (MPa) | (kJ/m²) |
| Example 1 | 46.5 | 41.0 | 30 | 56 | 1,745 | 8.5 |
| Example 2 | 47.0 | 42.5 | 27 | 57 | 1,810 | 8.0 |
| Comparative | 63.5 | 65.1 | 23 | 94 | 2,770 | 3.8 |
| Example 1 | | | | | | |
| Comparative | 44.0 | 42.0 | 24 | 59 | 1,880 | 6.5 |
| Example 2 | | | | | | |

As illustrated in Table 1, it may be confirmed that in Comparative Example 1 in which the low-viscosity polyester based polyurethane resin was not used, flexural modulus was significantly increased, such that the resin composition was not suitable for manufacturing a molding product, and tensile elongation and impact strength were significantly decreased.

Further, it may be confirmed that in Comparative Example 2 in which the maleic acid anhydride-modified polyethylene/octene copolymer was not used, tensile elongation and impact strength were significantly decreased.

On the contrary, it may be confirmed that in Example 1 in which the polyoxymethylene resin, the polyester based polyurethane resin, and the polyethylene/octene copolymer were used, a decrease in melt flow index may be minimized, such that the resin composition was suitable for manufacturing a molding product, tensile elongation and impact strength were significantly increased, and flexural strength and flexural modulus were suitable.

Therefore, the spirit of the present invention should not be limited to the above-described embodiments, and the following claims as well as all modified equally or equivalently to the claims are intended to fall within the scope and spirit of the invention.

1. A resin composition for a cable tie, the resin composition comprising a polyoxyinethylene resin, a polyester based polyurethane resin, and an acid-modified polyethylene/octene copolymer.

2. The resin composition of claim 1, wherein it contains 5 to 100 parts by weight of the polyester based polyurethane resin and 0.01 to 20 parts by weight of the acid-modified polyethylene/laetrile copolymer, based on 100 parts by weight of the polyoxymethylene resin.

3. The resin composition of claim 1, further comprising acid-modified polystyrene.

4. The resin composition of claim 3, wherein it contains 0.01 to 20 parts by weight of the acid-modified polystyrene, based on 100 parts by weight of the polyoxymethylene resin.

5. The resin composition of claim 1, further comprising an antioxidant.

6. The resin composition of claim 5, wherein it contains 0.01 to 20 parts by weight of the antioxidant, based on 100 parts by weight of the polyoxymethylene resin.

7. A cable tie manufactured using the resin composition of claim 1.

8. (canceled)
